(19) United States
(12) Patent Application Publication
(10) Pub. No.: US 2004/0201864 A1
(43) Pub. Date: Oct. 14, 2004

(54) Digital/optical hybrid printer utilizing reflective spatial light modulation technology

(75) Inventor: Sujatha Ramanujan, Pittsford, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/409,842

(22) Filed: Apr. 9, 2003

(51) Int. Cl. G06F 15/00; B41B 1/00

(52) U.S. Cl. 358/1.7

(57) ABSTRACT

The invention comprises a printer that has a conveyor (200) for holding photosensitive media, a lens positioned adjacent the conveyor, and an optical combiner (120) positioned with respect to the lens so as to direct light through the lens to the photosensitive media. The invention includes an optical printer (100) positioned to direct an optical exposure to the optical combiner, and a digital printer (110) positioned to direct a digital exposure (630) to the optical combiner. A controller is connected to the optical printer and the digital printer, and the optical printer and the digital printer are controlled by the controller so as to direct both the optical exposure and the digital exposure simultaneously to the optical combiner, which, in turn, passes the combined digital exposure through the lens to the photosensitive media.

### FIELD OF THE INVENTION

The invention relates to the field of printing on photosensitive paper and more particularly to a system of printing an optical exposure and a digital exposure on the photosensitive paper.

### BACKGROUND OF THE INVENTION

Developed film and digital images can be transferred to photographic paper in a number of different ways. For example, as described in U.S. Pat. No. 5,652,661 (incorporated herein by reference) an optical printer can transfer the developed film image onto the photographic paper. The optical printer typically includes a light source, focusing lens and development station. The film is illuminated by the light source and the image is transferred through the focusing lens to the photographic paper. Alternatively, the developed film image can be scanned into a processing unit and converted into a digital image. Scanned and digital film images and images obtained with digital equipment are generally printed with a digital printer.

Digital printers generally include light sources (color filtered incandescent lights, colored lasers, light emitting diodes (LEDs), etc.) that are selectively exposed on the photographic paper using a spatial light modulator such as a digital micromirror device (DMD) as discussed in U.S. Pat. No. 5,061,049 (incorporated herein by reference) or liquid crystal device (LCD). As with the optical system, the images produced are focused through a lens onto the photographic paper.

Some photographic systems combine digital printers with optical printers (see, for example, U.S. Pat. Nos. 6,025,904; 5,734,461; and 5,652,661, all of which are incorporated herein by reference). However, such systems separate the operation of the optical printer from the digital printer. This makes the printing process slower (because multiple operations must be performed on each photographic image) and makes the printing apparatus larger and more complicated (because multiple stations must be included within the printing apparatus). In addition, the particular methods of printing such as optical printing with a lamp house, and digital printing with laser based illumination require careful balancing of exposure times in order to avoid reciprocity failure at the media.

Scan based digital engines such as a laser marking engine, or linear CRT require the scanning apparatus be incorporated in the paper path. It is not always trivial to combine an area optical printer with a linear digital printer. Finally, the inclusion of a LCD based digital writer can be considerably more cost effective, particularly if the digital writer is not required to either print the entire image, or print at the same resolution.

### SUMMARY OF THE INVENTION

In view of the foregoing, the present invention has been created to provide a system that simultaneously performs optical and digital printing. More specifically, the present invention comprises a printer that has a conveyor for holding photosensitive media, a lens positioned adjacent the conveyor, and an optical combiner positioned with respect to the lens so as to direct light through the lens to the photosensitive media. The present invention includes an optical printer positioned to direct an optical exposure to the optical combiner, and a digital printer positioned to direct a digital exposure to the optical combiner. A controller is connected to the optical printer and the digital printer and the optical printer and the digital printer are controlled by the controller so as to direct both the optical exposure and the digital exposure simultaneously to the optical combiner, which, in turn, passes the combined digital exposure through the lens to the photosensitive media.

The optical printer can include an optical printer light source and the digital printer can include a separate digital printer light source. Alternatively, a common light source can be positioned with respect to the optical printer and the digital printer so as to provide light to both the optical printer and the digital printer. In such a situation, a beam splitter is positioned adjacent the common light source. The beam splitter can be adapted to variably divide light from the common light source between the optical printer and the digital printer so as to supply different amounts of light to the optical printer and the digital printer and satisfy the different illumination requirements of the optical printer and the digital printer. Also, the digital printer can include a spatial light modulator used to restrict the digital exposure to a limited region of the photosensitive media.

The present invention also provides a method of exposing a photosensitive media. This method positions the photosensitive media adjacent to a lens, positions an optical printer to transmit an optical exposure through the lens, positions a digital printer to transmit a digital exposure through the lens, and controls the optical printer and the digital printer to simultaneously transmit the optical exposure and the digital exposure through the lens to the photosensitive media.

The present invention produces a number of advantages when compared to conventional digital/optical printing systems. One advantage is that the invention simultaneously exposes the photosensitive material using the digital and optical printers. Also, the size of the composite system can be reduced through the use of a single light source. The use of a spatial light modulator (SLM) based digital engine eliminates the need for spinning polygons that laser systems employ. As SLM's are becoming readily available due to the proliferation in the projection industry, the net cost of this design is significantly less. With the use of multiple light sources as is described in certain embodiments, the color gamut is extended.

The uses of this system are many. First, text can be added to an optical print. The result could be greeting cards, business cards, brochures or any other printing product. In addition, a separate digital section to a printer may be particularly useful in motion picture film applications. For instance, many copies of a film may be made for distribution. While copies may be made conventionally, it is useful to be able to add the subtitles independently in whatever language is required. Also, adding copyright insignia's or “hidden” information can prevent piracy and copyright infringement. Finally, the digital channel can be used to correct imperfections in the original film images.

### BRIEF DESCRIPTION OF THE DRAWINGS

FIG. 1 is a schematic diagram illustrating an optical adder combining the output from a digital printer and an optical printer.

FIG. 2 is a schematic diagram of a conveyor system sequentially exposing a photosensitive material with an optical exposure and digital exposure.

FIG. 3 is a schematic diagram of an optical printer and a digital printer aimed at a single location.

FIG. 4 is a schematic diagram of an optical printer.

FIGS. 5A and 5B are schematic diagrams of digital printers.

FIG. 6 is a schematic diagram of a printing apparatus according to the present invention.

FIG. 7 is a schematic diagram of a printing apparatus according to the present invention.

FIG. 8 is a schematic diagram of a printing apparatus according to the present invention.

FIG. 9 is a schematic diagram illustrating the use of digital printing in a portion of an image.

FIG. 10 is a schematic diagram illustrating the use of digital printing in a portion of an image.

### DETAILED DESCRIPTION OF THE INVENTION

The present invention combines digital and optical printers into a single printer and simultaneously prints optically and digitally. In one example, the present invention combines a digital printer with a traditional film printer that illuminates film with a white light lamp source. The generated image is then passed through a projection lens to a media plane. In the digital leg, a transmissive spatial light modulator (SLM) display is illuminated with a lamp and filter wheel, LEDs, or lasers. The image is then relayed through the combiner to a print lens. In the case of an LCD display, the illumination needs to be polarized and the output analyzed.

It is important to recognize the purpose of the digital printer. If the intention is to create additional image data of some complexity, care must be taken with optical design. Specifically, the illumination assembly of the transmissive LCD should be telecentric in nature and extremely uniform. This then forces the print lens to be telecentric. Additionally, uniform optics such as integrating bars or lenslet arrays may be employed. If the image data projected by the LCD is not complex (i.e., a simple trademark insignia) the optical relay mechanism need not be telecentric. Furthermore, if the added digital data is monochromatic, the illumination source need not be broadband. If it is polychromatic, either a white light source with filters need be employed, or LEDs sequentially illuminated in a single LCD system are used.

At this point it is necessary to discuss the utilization of a LCD in a digital printer. LCDs are designed to present an image viewable by the eye. The eye's response to image data is quite different than photographic media response. Thus, with the present invention, the LCD or spatial light modulator is adjusted to operate in the dynamic range as well as the spectral range of the media. This may require adjusting the address voltage to determine a contrast as defined by the media. Additional address voltages, and drive conditions can be adjusted to deliver a response curve, or gamma curve, suitable to the media. Finally, address conditions, such as voltage can determine optimal response with respect to illumination wavelength. In the case of color sequential printing, the applied voltage may be cycled as a function of color.

Illumination time, and power are a function of the required exposure of the media. In as much as the image is a single composite image, the required exposure between the optical and digital engines is balanced with the invention. For example, if a region of the print is expected to have a density of 1.4, the optical engine may furnish 1.0, and the digital engine furnishes 0.4. Alternatively, each leg of the printer can illuminate a different area and be responsible for all the required density. In the case of digitally adding subtitles or information at max density, balance is not as critical, as one can simply give a max or over exposure to a region.

Another feature of the present invention relates to the use of alternate illumination such as infrared (IR) illumination. By illuminating the SLM with IR and then projecting the resultant image onto the media, one can incorporate “hidden” data, or trademark symbols to help prevent infringement.

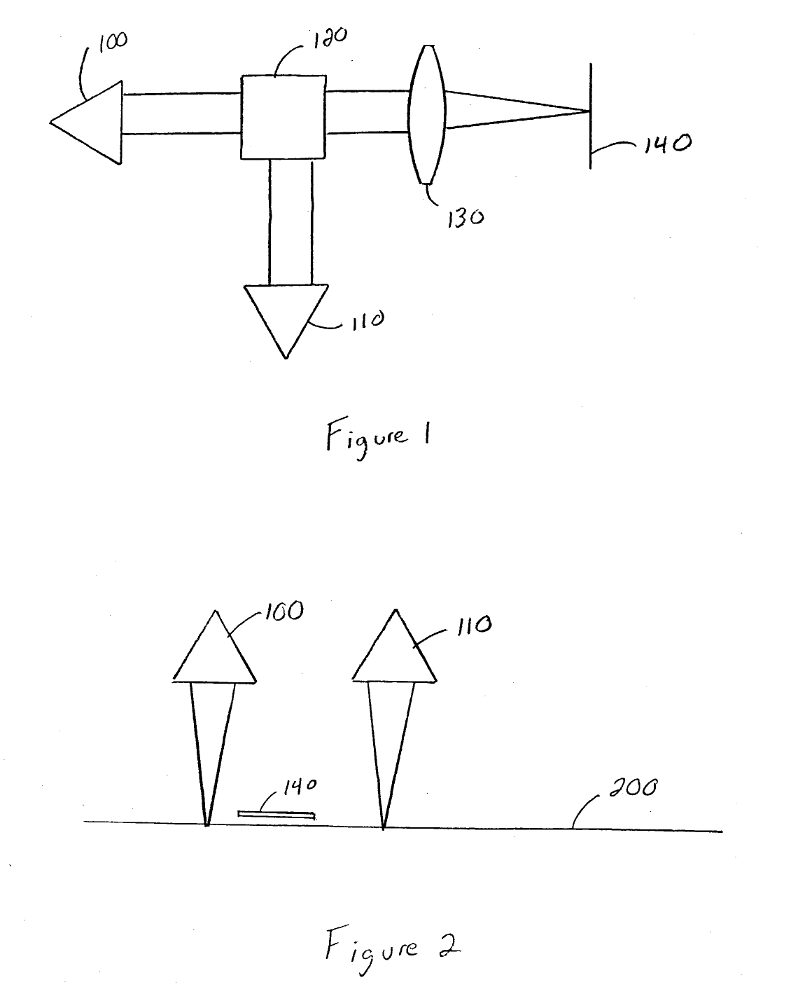

FIG. 1 illustrates one embodiment of the present invention that includes an optical printer 100 and a digital printer 110. The optical exposure output from the optical printer 100 is combined with the digital exposure output from the digital printer 110 by an optical adder or a beam splitter/recombiner 120. These combined exposures are then simultaneously imaged through a print lens 130 onto a photosensitive material 140.

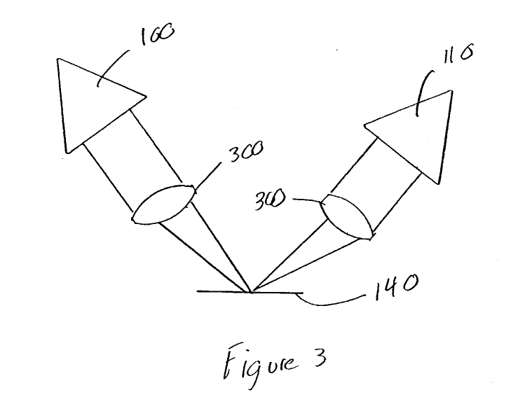

FIG. 2 illustrates a sequential processing apparatus whereby photosensitive material 140 is moved along a conveyor belt 200 and sequentially exposed by the optical printer 100 and the digital printer 110.

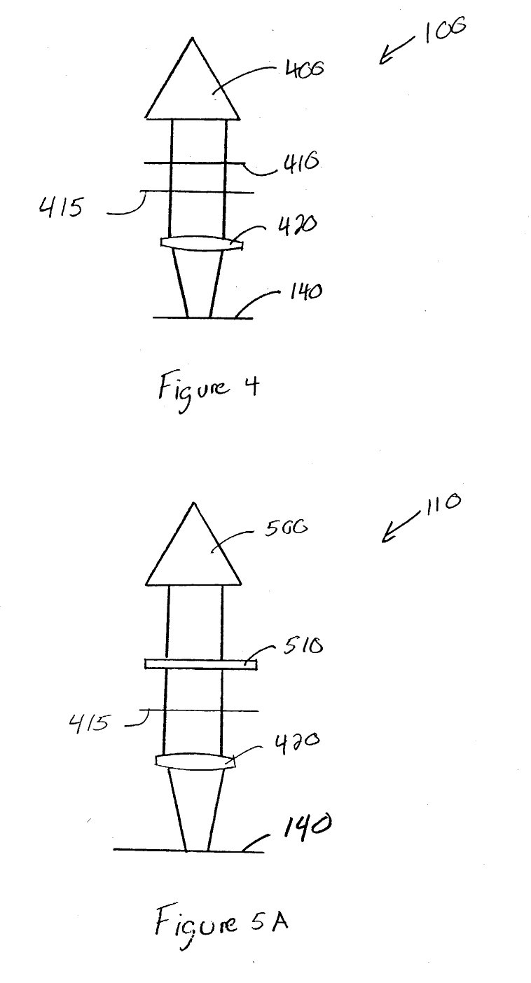

FIG. 3 illustrates another embodiment of the present invention where the optical printer 100 and the digital printer 110 are aimed at a single location on the photosensitive material 140. As with the structure shown in FIG. 1, the structure shown in FIG. 3 allows the optical printer and the digital printer to simultaneously expose the photosensitive material 140, while the structure in FIG. 2 does not.

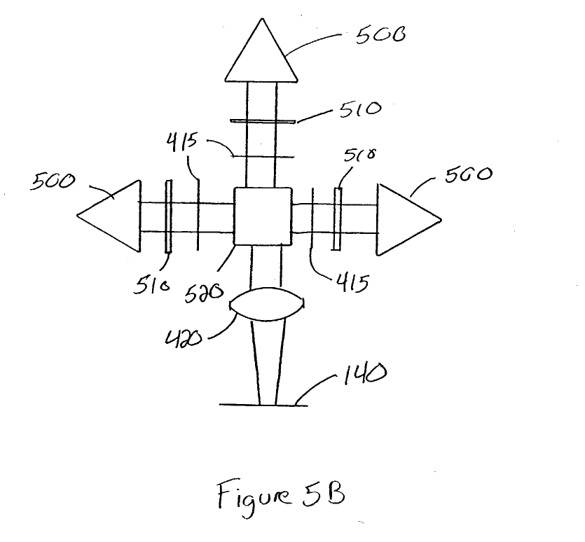

The details of one example of the optical printer 100 are shown in FIG. 4. More specifically, the optical printer 100 includes a light source 400 which can be any conventional source used to eliminate photosensitive material such as shuttered and colored filtered incandescent light sources, different colored laser lights sources, LEDs, infrared sources, etc. The developed film image is represented by item 410. The optical printer shown in FIG. 4 includes a number of structures that support the developed film image 410 and allow multiple film images to be passed through the optical printer. However, in order to more clearly illustrate the salient features of the present invention, such structures have been intentionally omitted from the drawing. In addition, the optical printer 100 includes some form of shutter or masking plate 415. The shutter/masking plate 415 controls the size and time of exposure of the optical engine. Alternatively, the light source may be directed modulated to effect shuttering. A focusing lens 420 focuses the exposed image on the photosensitive material 140.

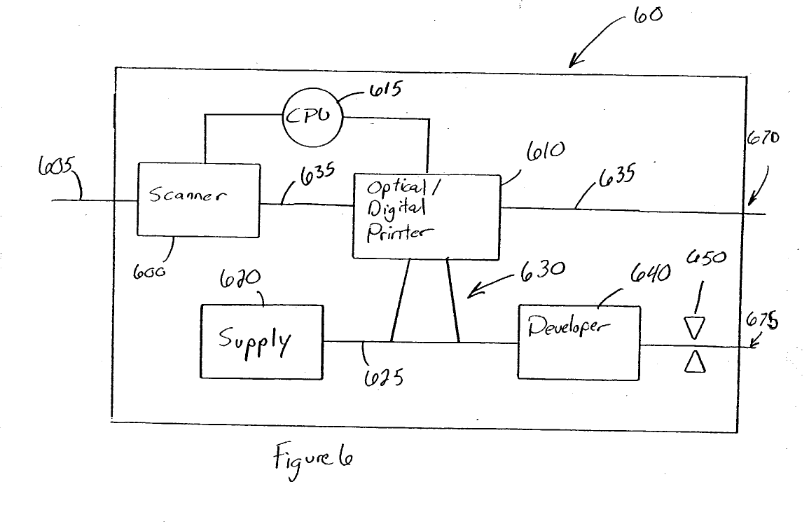

FIG. 5A illustrates one example of the digital printer 110 in greater detail. FIG. 5A illustrates a light source 500. As discussed above, such a light source can include shuttered (or modulated) and colored filtered incandescent light sources, different colored laser lights sources, LEDs, etc. The spatial light monitor is shown as item 510.

Color digital printers can operate in a sequential manner where different colors are illuminated in different exposure steps. Alternatively, the spatial light monitor 510 based system can comprise a color-based unit allowing a single exposure to produce a color image on the photosensitive material 140. This is achieved either through the incorporation of color filters on the SLM or through the use of a multichannel SLM system.

A multichannel system may incorporate, for example, a red, green, and blue channel. FIG. 5B illustrates a digital printer that includes such multiple illumination sources 500, multiple spatial light monitors 510 and multiple shutters 415. The light output from the different devices is combined using a light adder 520. In a similar manner to that discussed above, the focusing lens 420 focuses the light output from the adder on to the photosensitive material 140.

The optical/digital printer shown in FIG. 1 is shown in a complete system (an enclosed printer device) 60 as item 610 in FIG. 6. The developed film and/or digital image data is input by item 605 into the printer device 60. The developed optical film is scanned by a scanner 600 which provides a digital representation of the scanned image to the central processing units 615. Digital data is processed by a central processing unit 615. The developed optical film is passed from the scanner 600 to the optical/digital printers 610 and then to an output 670 using a conveyor system 635. Photosensitive paper 625 is provided from a supply 620 and is simultaneously exposed by optical and digital exposures 630 produced by the optical/digital printer 610 (as described above).

In addition, the system shown in FIG. 6 can be used to make film copies. For example, the supply 620 can contain unexposed movie film 625 that it exposed by the optical/digital printer 610. A developer/processor 640 processes the photosensitive paper/film 625. A cutter 650 optionally cuts the photosensitive paper into photographic prints and outputs the developed images through the output 675.

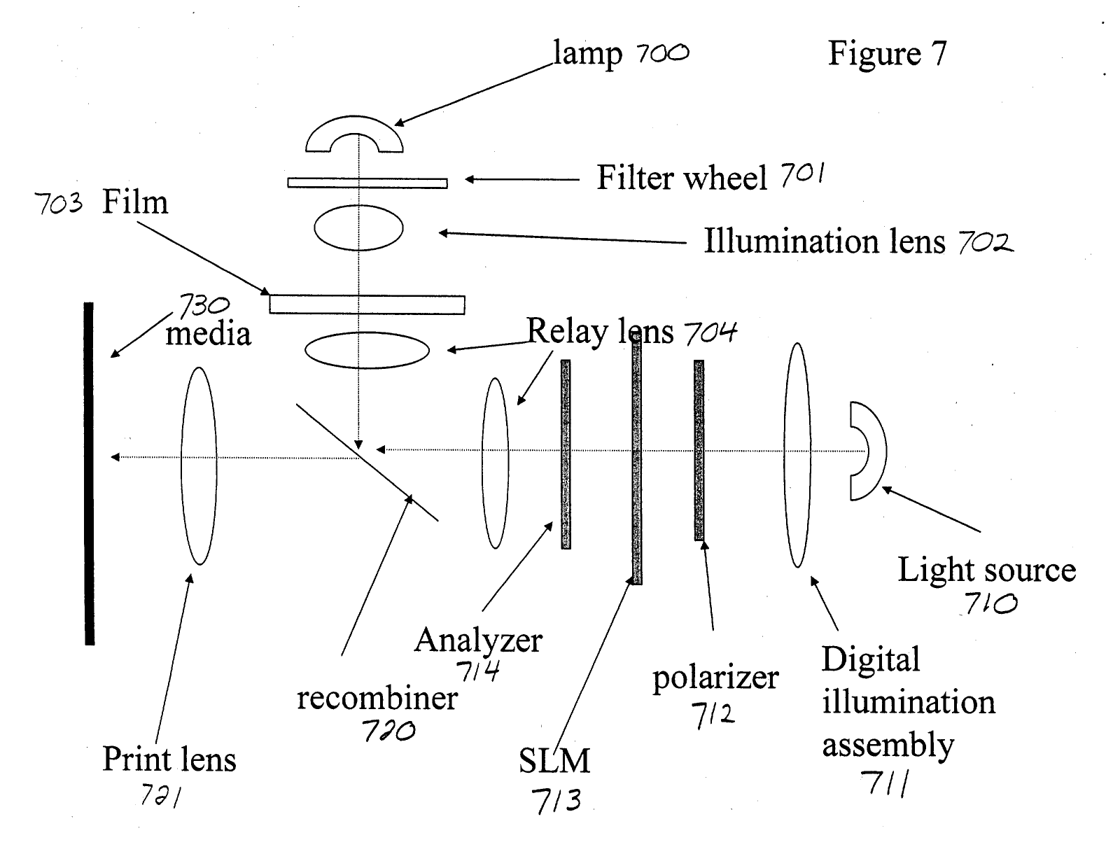

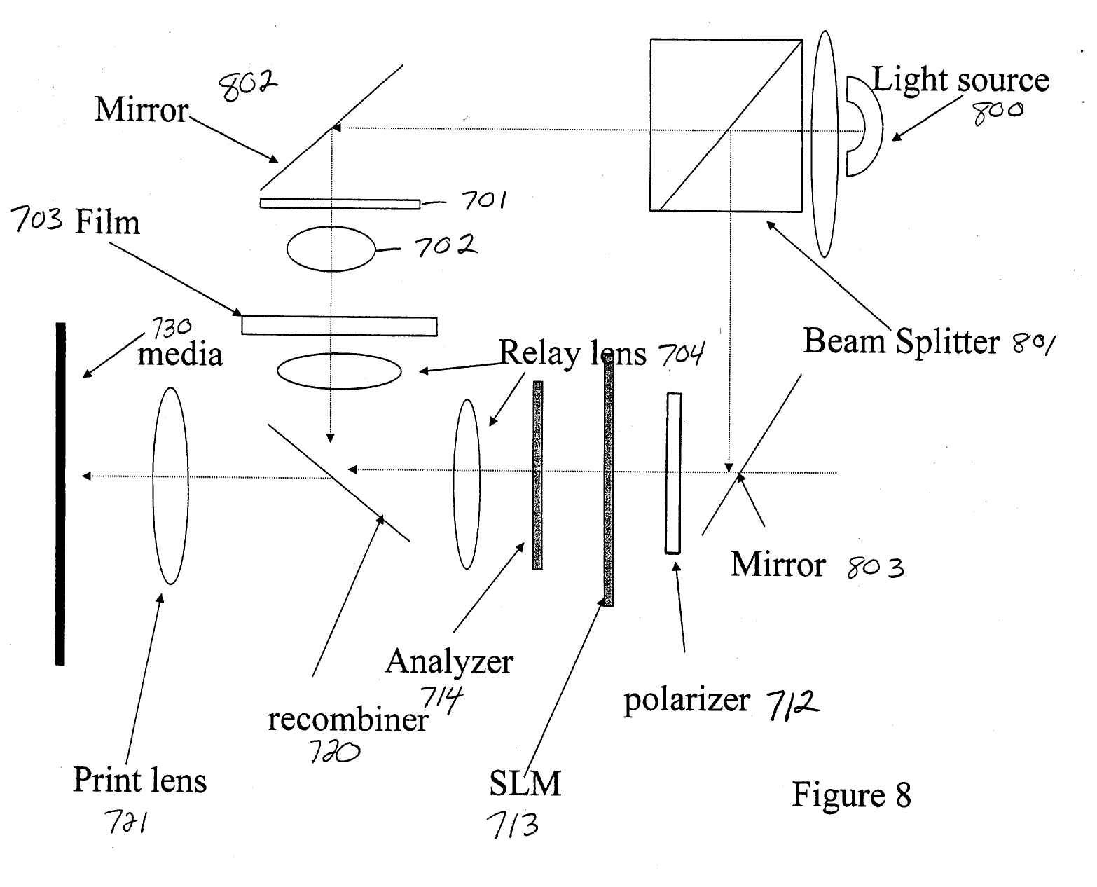

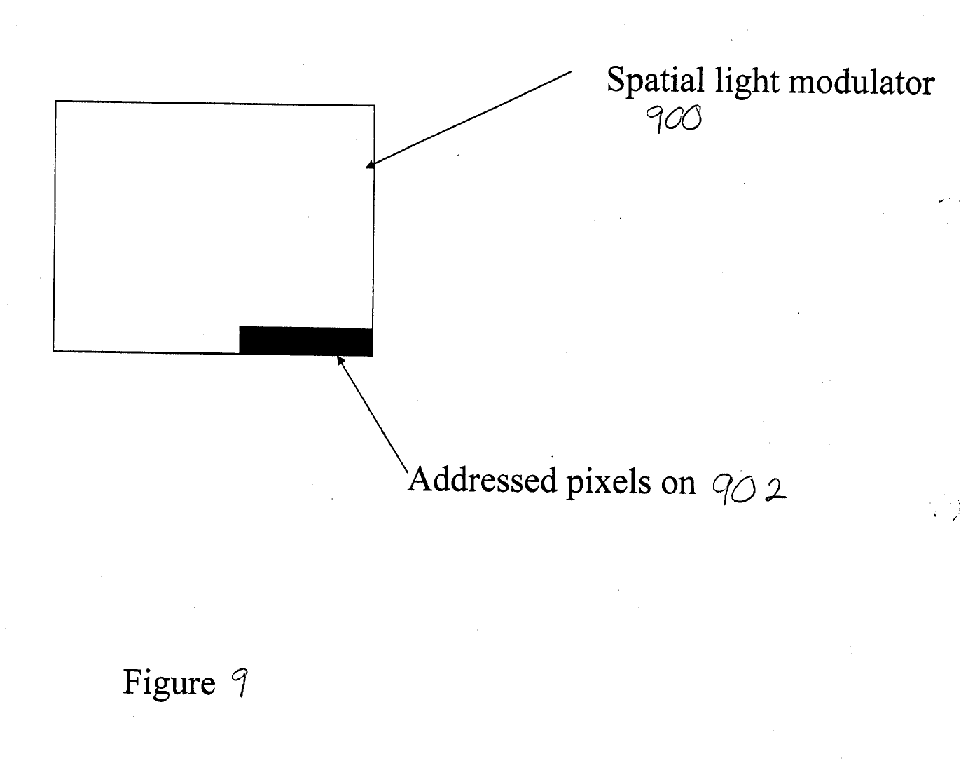

FIG. 7 illustrates in greater detail the components included within the inventive optical/digital printer. In the optical portion of the printer, a lamp 700 is used to provide illumination. The illumination is processed through the filter wheel 701 and the illumination lens 702 prior to passing through the optical image on the film 703. This image then passes through a relay lens 704 at which point it is combined with the digital image by the recombiner (optical combiner) 720. The combined optical/digital image is then directed through the print lens 721 and on to the photosensitive media 730.

The digital portion of the printer shown in FIG. 7 includes a light source 710 that produces light that is directed through a digital illumination assembly 711, a polarizer 712, the spatial light modulator 713, and an analyzer 714. As with the optical image, the digital images then passed through a relay lens 704, at which point it is combined with the optical image by the recombiner 720. The combined optical/digital image is then directed through the print lens 721 and on to the photosensitive media 730.

An alternate embodiment employs the same illumination source for the optical and digital engines. Such a system is shown in FIG. 8. A single light source (which may consist of a lamp and filter wheel, LEDs or lasers) 800 is split into two illumination paths by a beam splitter 801. Mirrors 802, 803 are used to direct the light through each of the optical and digital processing paths. In the case where the SLM is a LCD panel, the beam splitter may be a polarizing beam splitter that sends a preferential polarization state to the modulator in which case the polarizer 712 can be eliminated.

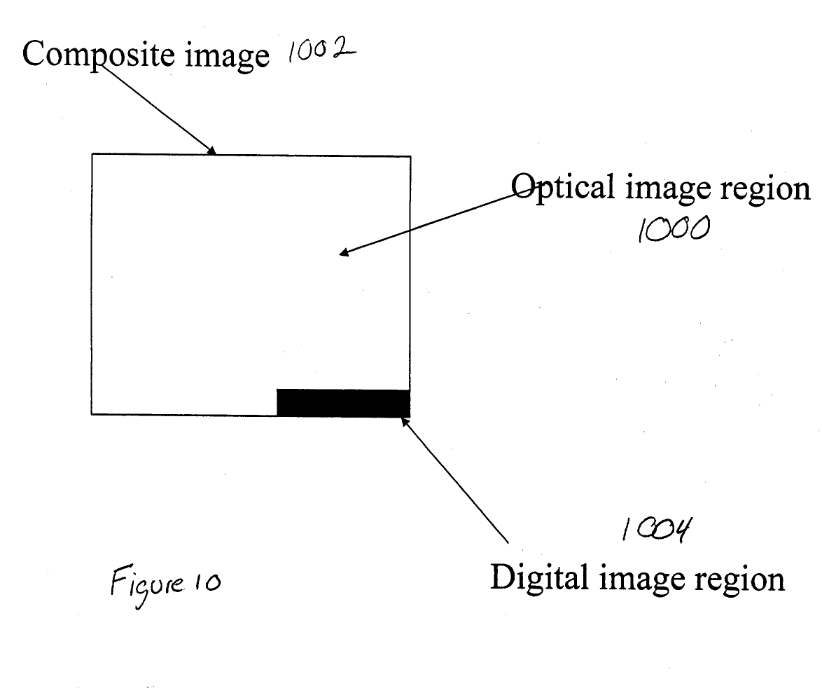

FIGS. 9 and 10 illustrate another aspect of the present invention that utilizes a regional area spatial light modulator 900 shown in FIG. 9. In FIG. 9, a region 902 of the spatial light modulator is addressed with “on” pixels. The rest of the device is loaded with data corresponding to “off” pixels (or vice versa). In the image 1000 shown in FIG. 10, only the same region 1004 of the composite image 1002 displays digital data. One advantage of such a system is that the location, content, and extent of the digital data can be adjusted on a frame by frame basis. For example, when printing greeting cards, text can appear in different regions.

The present invention produces a number of advantages when compared to conventional digital/optical printing systems. One advantage is that the invention simultaneously exposes the photosensitive material using the digital and optical printers. In one embodiment, the digital printing aspect is monochromatic and of a lower resolution than the optical system. This allows the exposure times of the digital to be less than previous embodiments.

Further, the present invention corrects the optical differences between the digital printing and optical printing systems. For example, in the case where the aspect ratio of the SLM does not match the aspect ratio of the print or of the optical image, anamorphic lenses can be used to resize the image of the SLM to whatever proportion is required. Suppose, a square SLM employed to create a rectangular image within the image plane, cylindrical or anamorphic lenses in the path or as a printing lens could be employed. Alternatively, a portion of the SLM employed that corresponds to the required image size, can be addressed.

It should be noted that specific examples of optical architecture have shown a transmissive LCD. This system could easily employ a reflective LCD, or DMD with equal ease.

The proposed structure has many uses and advantages. First of all, the size of the composite system can be reduced through the use of a single light source. Also, the use of an SLM based digital engine eliminates the need for spinning polygons that laser systems employ. Also, the SLM's are becoming readily available due to the proliferation in the projection industry, the net cost of this design is significantly less. With the use of multiple light sources as is described in certain embodiments, the color gamut is extended.

The uses of this system are many. First, text can be added to an optical print. The result could be greeting cards, business cards, brochures or any other printing product. In addition, a separate digital section to a printer may be particularly useful in motion picture film applications. For instance, many copies of a film may be made for distribution. While copies may be made conventionally, it is useful to be able to add the subtitles independently in whatever language is required. Also, adding copyright insignia's or “hidden” information can prevent piracy and copyright infringement (using the infrared exposure embodiment discussed above). Finally, the digital channel can be used to correct imperfections in the original film images.

The invention has been described in detail with particular reference to certain and preferred embodiments thereof, but it will be understood that variations and modifications can be effected within the scope of the.

### Parts List

60 Printing device

100 Optical printer

110 Digital printer

120 Optical adder or beam splitter/recombiner

130 Print lens

140 Photosensitive material

200 Conveyor belt

300 Photosensitive media

400 Light source

410 Film image

415 Shutter or masking plate

420 Focusing/imaging lens

500 Multiple illumination sources

510 Spatial light modulator

520 Light adder

600 Scanner

605 Input item

610 Optical/digital printer

615 Central processing unit

620 Supply

625 Paper/film

630 Digital exposures

635 Conveyor system

640 Developer/processor

650 Cutter

670 Output

675 Output

700 Lamp

701 Filter wheel

702 Illumination lens

703 Film

704 Relay lens

710 Light source

711 Illumination assembly

712 polarizer

713 Spatial light modulator

714 Analyzer

720 Recombiner

721 Print lens

730 Photosensitive media

800 Single light source

801 Beam splitter

802 Mirror

803 Mirror

900 Regional area spatial 902 light modulator

902 Region

1000 Image

1002 Composite image

1004 Region

What is claimed is:

1. A system comprising:
an optical printer;
a digital printer positioned adjacent to said optical printer; and
wherein said optical printer is adapted to direct an optical exposure to an area of a photosensitive media and said digital printer is adapted to simultaneously direct a digital exposure to said area of said photosensitive media.

2. The system in claim 1, further comprising a lens adjacent said area of said media, wherein said optical printer and said digital printer are positioned with respect to said lens so as to direct both said optical exposure and said digital exposure simultaneously through said lens.

3. The system in claim 1, further comprising an optical combiner positioned with respect to said optical printer and said digital printer so as to receive said optical exposure and said digital exposure, wherein said optical combiner is adapted to combine said optical exposure and said digital exposure into a combined exposure.

4. The system in claim 3, further comprising a lens adjacent said area of said photosensitive media, wherein said optical combiner is positioned with respect to said lens so as to direct said combined exposure through said lens to said area of said photosensitive media.

5. The system in claim 1, wherein said optical printer includes an optical printer light source and said digital printer includes a digital printer light source.

6. The system in claim 1, further comprising a common light source positioned with respect to said optical printer and said digital printer so as to provide light to both said optical printer and said digital printer.

7. The system in claim 6, further comprising a beam splitter adjacent said common light source, wherein said beam splitter is adapted to variably divide light from said common light source between said optical printer and said digital printer so as to supply different amounts of light to said optical printer and said digital printer and satisfy different illumination requirements of said optical printer and said digital printer.

8. The system in claim 1, wherein said digital printer includes a spatial light modulator adapted to restrict said digital exposure to a limited portion of said area of said photosensitive media.

9. A printer comprising:
a conveyor for holding photosensitive media;
a lens positioned adjacent said conveyor;
an optical printer positioned to direct an optical exposure through said lens to said photosensitive media;
a digital printer positioned to direct digital exposure through said lens to said photosensitive media;
a controller connected to said optical printer and said digital printer; and
wherein said optical printer and said digital printer are controlled by said controller so as to direct both said optical exposure and said digital exposure simultaneously through said lens to said photosensitive media.

10. The printer in claim 9, further comprising an optical combiner positioned with respect to said optical printer and said digital printer so as to receive said optical exposure and said digital exposure, wherein said optical combiner is adapted to combine said optical exposure and said digital exposure into a combined exposure.

11. The printer in claim 10, wherein said optical combiner is positioned with respect to said lens so as to direct said combined exposure through said lens to said photosensitive media.

12. The printer in claim 9, wherein said optical printer includes an optical printer light source and said digital printer includes a digital printer light source.

13. The printer in claim 9, further comprising a common light source positioned with respect to said optical printer and said digital printer so as to provide light to both said optical printer and said digital printer.

14. The printer in claim 13, further comprising a beam splitter adjacent said common light source, wherein said beam splitter is adapted to variably divide light from said common light source between said optical printer and said digital printer so as to supply different amounts of light to said optical printer and said digital printer and satisfy different illumination requirements of said optical printer and said digital printer.

15. The printer in claim 9, wherein said digital printer includes a spatial light modulator adapted to restrict said digital exposure to a limited region of said photosensitive media.

16. A printer comprising:
a conveyor for holding photosensitive media;
a lens positioned adjacent said conveyor;
an optical combiner positioned with respect to said lens so as to direct light through said lens to said photosensitive media;
an optical printer positioned to direct an optical exposure to said optical combiner;
a digital printer positioned to direct digital exposure to said optical combiner;
a controller connected to said optical printer and said digital printer; and
wherein said optical printer and said digital printer are controlled by said controller so as to direct both said optical exposure and said digital exposure simultaneously to said optical combiner.

17. The printer in claim 16, wherein said optical combiner is adapted to combine said optical exposure and said digital exposure into a combined exposure.

18. The printer in claim 17, wherein said optical combiner is positioned with respect to said lens so as to direct said combined exposure through said lens to said photosensitive media.

19. The printer in claim 16, wherein said optical printer includes an optical printer light source and said digital printer includes a digital printer light source.

20. The printer in claim 16, further comprising a common light source positioned with respect to said optical printer and said digital printer so as to provide light to both said optical printer and said digital printer.

21. The printer in claim 20, further comprising a beam splitter adjacent said common light source, wherein said beam splitter is adapted to variably divide light from said common light source between said optical printer and said digital printer so as to supply different amounts of light to said optical printer and said digital printer and satisfy different illumination requirements of said optical printer and said digital printer.

22. The printer in claim 16, wherein said digital printer includes a spatial light modulator adapted to restrict said digital exposure to a limited region of said photosensitive media.

23. A method of exposing a photosensitive media comprising:
positioning said photosensitive media adjacent a lens;
positioning an optical printer to transmit an optical exposure through said lens;
positioning a digital printer to transmit a digital exposure through said lens; and
controlling said optical printer and said digital printer to simultaneously transmit said optical exposure and said digital exposure through said lens to said photosensitive media.

24. The method in claim 23, further comprising positioning an optical combiner between said optical and digital printers and said lens, such that said optical printer and said digital printer transmit said optical exposure and said digital exposure to said optical combiner and said optical combiner transmits a combined exposure to said lens.

25. The method in claim 23, further comprising providing separate light sources for said optical printer and said digital printer.

26. The method in claim 23, further comprising providing a common light source for said optical printer and said digital printer.

27. The method in claim 23, further comprising restricting said digital exposure to a limited region of said photosensitive media using a spatial light modulator.

28. A method of exposing a photosensitive media comprising:
positioning an optical printer to transmit an optical exposure to an area of said photosensitive media;
positioning a digital printer to transmit a digital exposure to said area of said photosensitive media; and
controlling said optical printer and said digital printer to simultaneously transmit said optical exposure and said digital exposure to said area of said photosensitive media.

29. The method in claim 28, further comprising positioning an optical combiner between said optical and digital printers and said photosensitive media, such that said optical printer and said digital printer transmit said optical exposure and said digital exposure to said optical combiner and said optical combiner transmits a combined exposure to said photosensitive media.

30. The method in claim 28, further comprising providing separate light sources for said optical printer and said digital printer.

31. The method in claim 28, further comprising providing a common light source for said optical printer and said digital printer.

32. The method in claim 28, further comprising restricting said digital exposure to a limited region of said area of said photosensitive media using a spatial light modulator.
